(19) United States
(12) Patent Application Publication
(10) Pub. No.: US 2014/0244666 A1
(43) Pub. Date: Aug. 28, 2014

(54) SYSTEMS AND METHODS FOR PREVENTING OVERLOAD OF AN APPLICATION

(71) Applicant: RED HAT, INC., Raleigh, NC (US)

(72) Inventors: Filip Elias, Vysni Lhoty (CZ); Filip Nguyen, Brno (CZ)

(73) Assignee: Red Hat, Inc., Raleigh, NC (US)

(21) Appl. No.: 13/777,783

(22) Filed: Feb. 26, 2013

(51) Int. Cl. G06F 17/30

(52) U.S. Cl. CPC G06F 17/3053
USPC 707/751

(57) ABSTRACT

A mechanism for preventing overload of application is disclosed. A method includes receiving a query submitted by a user, the query includes user identification (ID) and an operation to be processed by an application. The method also includes filtering user records to identify subset of the user records associated with the user ID and determining quality of service (QoS) ranking from the subset of the user records associated with the user ID. The method also includes submitting the query to the application when the determined QoS ranking is assigned with high ranking. The method also includes filtering query records to identify subset of the query records associated with the query when the determined QoS ranking is assigned with low ranking. The method further includes determining quality string (QS) rating associated with the subset of query records and providing a decision on the query in view of the determined QS rating.

### TECHNICAL FIELD

The embodiments of the disclosure relate generally to a computer system and, more specifically, relate to systems and methods for preventing overload of an application.

### BACKGROUND

When a remotely accessed application is accessed, there may be many sources such as number of requests, bandwidth availability, network ports and many more that contribute to overload of the accessed application. Currently, many generic techniques exists that attempt to prevent such an overload of the application. One known technique is firewall. Firewall is software that controls incoming and outgoing network traffic by analyzing data and determining whether it should be allowed through or not, based on a predetermined rule set. However, firewall does not take a logged user (e.g., context of an application) into account and does not communicate with a web server (e.g., web server (WS) Integration).

Other techniques include load balancing (LB) and horizontal scalability (HS). Both LB and HS techniques are computer networking mechanisms to distribute workload across multiple computers, network links, central processing units (CPUs), disk drives, or other resources. However, both LB and HS do not take a logged user and data submitted by the logged user into account when distributing the workload.

Another known technique includes Apache mod_qos, which is a module for an open source HyperText Transport Protocol (HTTP) server. The Apache mod_qos module may include a small processing core for HTTP request processing and multi-processing modules (MPM), which dispatches the HTTP request processing to threads and/or processes. However, Apache mod_qos also does not take a logged user into account when dispatching the HTTP request.

### BRIEF DESCRIPTION OF THE DRAWINGS

The disclosure is understood more fully from the detailed description given below and from the accompanying drawings of various embodiments of the disclosure. The drawings, however, should not be taken to limit the disclosure to the specific embodiments, but are for explanation and understanding only.

FIG. 1 is a block diagram of a computer system in which the embodiments of the present disclosure may operate;

FIG. 2 illustrates an example of a table of user records in a Direct Interface Array of a computer system in accordance with some embodiments;

FIG. 3 illustrates an example of a table of query records in the Direct Interface Array of a computer system in accordance with some embodiments;

FIGS. 4A and 4B are flow diagrams of one embodiment of a method for preventing overload of application; and

FIG. 5 illustrates a block diagram of one embodiment of a computer system.

### DETAILED DESCRIPTION

Embodiments of the disclosure are directed to a method and system for preventing overload of an application in a computer system. Embodiments of the disclosure function to prevent overload both based on a user and a query submitted by the user. An overload may occur when number of queries received to be processed by the application in the computer system are more than it can handle. Embodiments of the disclosure are also directed to preventing a privileged user to access the system, that would otherwise be overloaded.

In one embodiment, an application request rating (ARR) is a database in a computer system that stores records associated with a user. The user may include a human or software (implemented via computer-readable instructions) that sends requests for operation to be processed by the application in the computer system. In some embodiments, the ARR stores records associated with a query. In one embodiment, a query is a message including an operation to be processed by the application.

In one embodiment, an dynamic application proxy (DAP) executed by the computer system receives a new query submitted by the user. The new query may include a user identification (ID) and an operation to be processed by the application. The DAP may filter the user records of the ARR to identify a subset of user records associated with user ID in the new query. The DAP may also determine quality of service (QoS) ranking of the user from the subset of the user records associated with the user ID. The QoS ranking may include one of a high or a low ranking.

In one embodiment, some user records include user ALL instead of a specific user ID. When the record contains user ALL, it may be matched with any user ID in the query. So one query having one user ID may match many records that include ALL. The DAP may identify the QoS ranking of the user in the ALL user records.

The DAP may submit the new query to the application when the QoS ranking includes a high ranking. The DAP may filter the query records of the ARR to identify a subset of query records associated with the new query when the QoS ranking includes a low ranking. The DAP may also determine query string rating (QS) associated with the subset of the query records. The QS rating may include one of a high, medium or low rating.

In a further embodiment, the DAP detects utilization of the application when the QS rating of the new query is assigned with a high rating. In one embodiment, the DAP passes the new query to the application when the utilization of the application is below the threshold. The DAP may delay submitting of the new query to the application when the utilization is above the threshold. The DAP may further place the new query in a priority queue when the submitting of the new query is delayed due to utilization levels.

In one embodiment, the DAP delays submitting the new query to the application when the QS rating of the new query is assigned with a medium rating. In one embodiment, the DAP places the new query in a priority queue. The DAP may reject submitting the new query to the application when the QS rating of the new query is assigned with a low rating.

A method of one embodiment of the disclosure includes receiving a query submitted by a user. The query may include user identification (ID) and an operation to be processed by an application. The method may include filtering user records to identify a subset of the user records associated with the user ID. The method may also include determining quality of service (QoS) ranking from the subset of user records associated with the user ID. The method may further include submitting the query to the application when the determined QoS ranking associated with the user ID includes a high ranking.

The method may also include filtering query records to identify a subset of the query records when the determined QoS ranking associated with the user ID includes a low ranking. In addition, the method may include determining a quality string (QS) rating associated with the subset of the query records. The method may further include providing a decision on the query in view of the determined QS rating. In one embodiment, the decision includes at least one of a pass, a delay or a rejection of the query to the application.

Prior solutions for preventing overload of applications present several disadvantages. For example, load balancing (LB) and horizontal scalability (HS) methods distribute workload across multiple resources. However, both LB and HB do not take logged user and data submitted by the logged user into account. Firewall is another prior solution that analyzes the data of the incoming and outgoing traffic. However, similar to the other prior solutions, firewall also fails to take a logged user (e.g., context of the application) into account and does not communicate with a web server. Another prior solution is Apache mod_qos, which processes HTTP request. Apache mod_qos also fails to take a logged user into account. Embodiments of the disclosure overcome these disadvantages by ranking the users and providing a decision of passing, delaying or rejecting the data submitted by the user based on both the ranking of the users and the rating of the data.

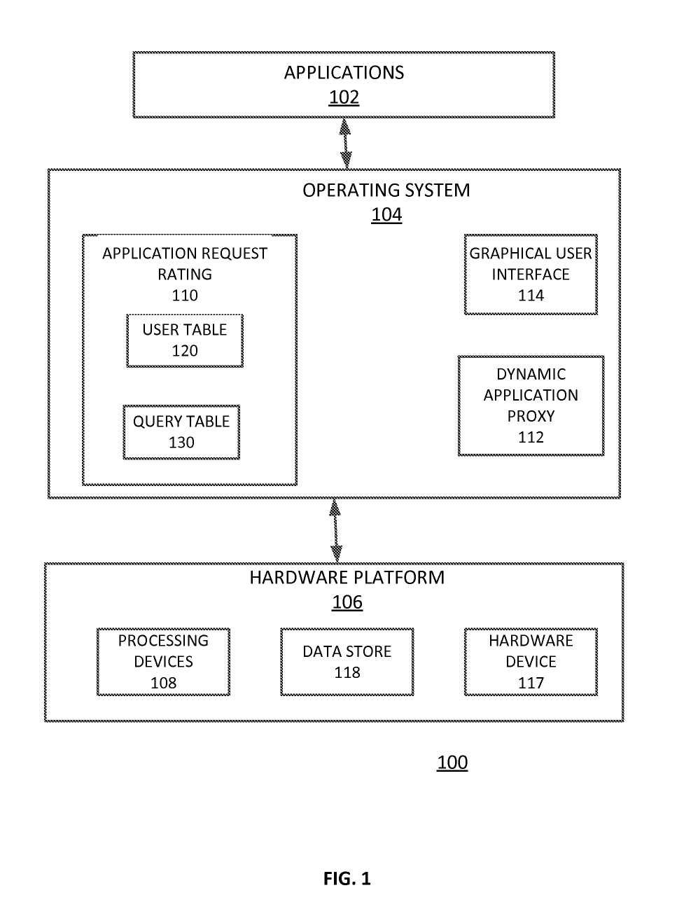

FIG. 1 is a block diagram illustrating a computer system 100 in which embodiments of the present invention may be implemented. In one embodiment, the computer system 100 may be a machine such as, for example, any variety of user devices, such as a personal computer (PC), a laptop, a mobile phone, mobile smart phone, a tablet computer, handheld devices, netbooks, or any other computing device. Furthermore, computer system 100 may comprise a server device, such as a main frame server device or any other type of server device. The computer system 100 comprises a hardware platform 106, on top of which runs an operating system (OS) 104. The OS 104 may include Microsoft™, Linux™, Solaris™, Mac™ OS or any other suitable OS for managing operations on the computer system 100.

The hardware platform 106 may include one or more processing devices 108 and a data store 118. In one embodiment, the data store 118 comprises one or more hardware or software devices, which may be located internally or externally to the computer system 100. Examples of data store 118 may include, but are not limited to, random-access memory (RAM), non-volatile storage memory (e.g., Flash, EEPROM, solid state drives (SSD), etc.), magnetic storage memory (e.g., one or more hard drives), and optical memory (e.g., CDs, DVD, BlueRay drives, etc.). In addition, hardware platform 106 may include additional hardware devices 117, such as network interface cards (NICs), sound or video adaptors, photo/video cameras, printer devices, keyboards, displays or any other suitable device intended to be coupled to a computer system.

The computer system 100 may include one or more software application programs 102 (i.e. applications) running on top of the OS 104. The applications 102 may be any computer-executable program capable of communicating with the OS 104. Some of these applications may include, but are not limited to, web applications, Microsoft™ applications, an Eclipse integrated development environment (IDE), and/or other applications. In one embodiment, application 102 is a collection of resources, where each resource may be viewed, created, updated or deleted. In some embodiments, the various resources are rated according to their importance to user.

In one embodiment, the OS 104 includes an Abstract Request rating (ARR) 110 storing records of users (“user records”). In one embodiment, the user is one of a human or software, implemented via computer-readable instructions, who sends requests for operations to be processed by the applications 102 of the OS 104. The user records may include identification unique to the user (user ID) and a quality of service (QoS) ranking associated with the user. The QoS ranking is a status assigned to the user based on one or more factors. Some of the these factors may include, but are not limited to, employee position of the user, type of business specific subscription of the user, direct payment for improved QoS and identification as an administrator of the system etc.

In one embodiment, the QoS ranking may include, but is not limited to, one of a high or low ranking. The high and low ranking may be determined based on numerical value. In one embodiment, the user records of the ARR 110 are sorted so that the user IDs associated with the high QoS ranking are prioritized over the user IDs associated with the low QoS ranking. The ARR 110 may include a user table 120 listing the sorted records of the user based on the QoS rankings of the user IDs.

In one example, the user may have a position of an administrator that is assigned with the high QoS ranking. In another example, the user may have a maximum business specific subscription that is assigned with the high QoS ranking. In a further example, the user may have a minimum business subscription that is assigned with the low QoS ranking.

The OS 104 also includes a dynamic application proxy (DAP) 112 to prevent overload of the application 102 in the computer system. The DAP module 112 may provide a decision on a new query submitted by a user, where the decision is based on the QoS ranking of the user. In one embodiment, the query is a message including an operation to be processed by the application. Examples of operations include, but are not limited to, log in request, status request, creation of order request, list of products request, delete request, item update request. The new query is received by the OS 104. The decision may include passing the new query to the application 102 when the user is assigned with the high QoS ranking. On the other hand, the decision may include delaying submission of the new query to the application 102 when the user is assigned with the low QoS ranking. In some embodiments, the decision includes rejecting the new query (without sending to the application) when the user is assigned with the low QoS ranking.

In one example, the user is an administrator and is assigned with the high QoS ranking. As a result, all queries associated with the administrator are passed to the application.

In one embodiment, the ARR 110 may store records of the queries. As discussed above, the query may be a message including an operation to be processed by the application. The query records may include templates of queries, which match the queries submitted by the user and a query string (QS) rating of the corresponding query. In one embodiment, the QS rating is a metric assigned to the query based on operations included in the query. Some of these operations include, but are not limited to, log in request, status request, creation of order request, list of products request, delete request, item update request.

The QS rating may include one of a high QS rating, a medium QS rating or low QS rating. In one embodiment, the high, medium and low QS rating are implentor specific. The high, medium and low QS rating may be determined based on a numerical value. In one embodiment, the query records of the ARR 110 are sorted so that the queries associated with the high QS rating are prioritized over the queries associated with the medium QS rating, which are, in turn, prioritized over the queries associated with the low QS rating. The ARR 110 may include a query table 130 listing the sorted records of the query based on the QS rating of the queries.

In one example, the query may include a creation of order request and is assigned with the high QS rating. In another example, the query may include a status request and is assigned with the medium QS rating. In a further example, the query may include a log in request and is and is assigned with the low QS rating.

In one embodiment, the DAP module 112 provides a decision on a new query submitted by the user, where the decision is based on the QS rating. The decision may include submitting the query to the application 102 when the QS rating is assigned with high QS rating. The decision may also include delaying the submission of the query to the application 102 when the QS rating is assigned with medium QS rating. The decision may further include rejecting the submission of the query to the application when the QS rating is assigned with low QS rating.

In one embodiment, the DAP module 112 provides a decision on the new query submitted by the user based on the ARR. As discussed above, the ARR may include a combination of user records and query records. An example of a function run by the ARR is detailed below:

<query string rating>::=<URL> ” ”<method> ”:”<user> <rating>
<user> ::= [user ID] | [user ID] ”,” <user> | ”ALL”
<rating> ::= [numerical 1-10] | ”PASS”
<URL> ::= ”ALL” | [wildcarded URL]
<method> ::= ”ALL” | ”POST” | ”GET” | ”DELETE” | ”PUT” |
”OPTIONS” | ”HEAD” | ”CONNECT” | ”TRACE”

In some embodiments, the DAP module 112 receives a new query submitted by a user. In one embodiment, the new query includes a user ID of the submitted user and the operation to be processed by the application. The DAP module 112 may filter the user records of the ARR 110 to identify a subset of user records associated with user ID. The DAP module 112 may determine the QoS ranking of the submitted user from the subset of user records associated with the user ID. In one embodiment, the QoS ranking of the first user record is identified from the subset of user records. In one embodiment, the QoS ranking of the user record with high ranking is identified from the subset of the of user records.

In one embodiment, some user records include user ALL instead of a specific user ID. When the record contains user ALL, it may be matched with any user ID in the query. So a query having one user ID may match many records that include user ALL. The DAP may identify the QoS ranking of the first user in the ALL user records. The DAP may identify the high QoS ranking of the user in the ALL user records.

In one example, the QoS ranking associated with the user ID is assigned with a high QoS ranking. The DAP module 112 may then pass the new query to the application.

In another example, the QoS ranking associated with the user ID is assigned with low QoS ranking. The DAP module 112 may then filter the query records of the ARR 110 to identify a subset of the query records associated with the new query. The DAP module 112 may determine QS rating of the new query from the subset of query records associated with the new query. In one embodiment, the query record with a high QS rating is identified. The QS rating of the first query record from the subset of query records may be identified from the subset of query records.

In a further example, the new query submitted by the user is assigned with high QS rating. The DAP module 112 may detect utilization of the application 102. Utilization is amount of operations being processed in the application. In one embodiment, the DAP module 112 passes the new query to the application when the utilization of the application is not above a threshold. In one embodiment, threshold is a percentile value assigned to the utilization of the application. The threshold may be assigned by the user of the system. The DAP module 112 may delay submission of the new query to the application when the utilization of the server is above the threshold. In one embodiment, the DAP module 112 may place the new query in a priority queue when the submission of the new query is delayed because the utilization it is not above the threshold. In one embodiment, the priority queue is similar to a regular queue, i.e. first in, first out manner, but where additionally each queue has a “priority” associated with it. In the priority queue, the queue with high priority is passed to the application before the queue with low priority. If two queues have the same priority, they are passed to the application according to their order in the queue.

In an additional example, the new query submitted by the user is assigned with the medium QS rating. The DAP module 112 may delay the new query to be submitted to the application. In one embodiment, the DAP module 112 places the new query in the priority queue. As discussed above, the priority queue is similar to a regular queue, but where additionally each queue has a “priority” associated with it. In the priority queue, the queue with high priority is passed to the application before the queue with low priority. If two queues have the same priority, they are passed to the application according to their order in the queue. In one embodiment, the new query submitted by the user is assigned with the low QS rating. The DAP module 112 may reject submission of the new query to the application. The OS 104 may also include a graphical user interface (GUI) 114 configured to display the decision of the DAP module 112 on the query.

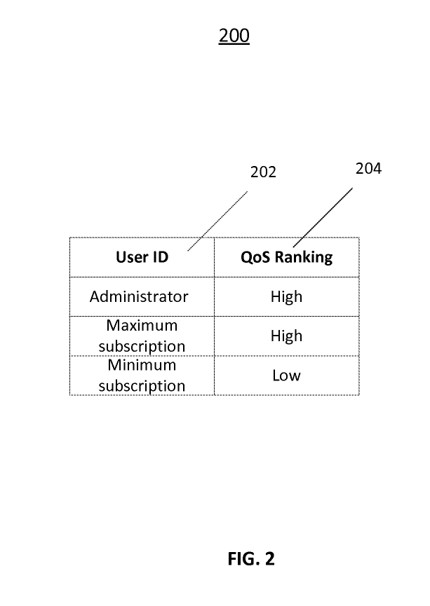

FIG. 2 illustrates an example of a table 200 of user records stored in the ARR 110 of an operating system according to embodiments of the disclosure. In one embodiment, table 200 is the same as the user table 120 of ARR 110 in FIG. 1. As illustrated, table 200 includes columns identifying user ID 202, and the QoS ranking 204 associated with the user ID 202. Examples of types of user IDs 202 may include, but are not limited to, an administrator, maximum subscription and low subscription. Examples of types of QoS ranking may include, but are not limited to, a high ranking associated with the administrator, a high ranking associated with the maximum subscription and low ranking associated with the minimum subscription.

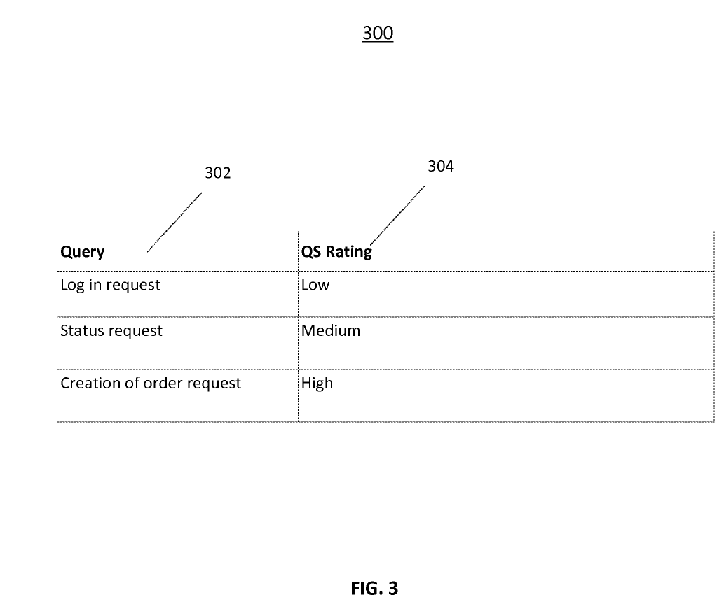

FIG. 3 illustrates an example of a table 300 of query records stored in the ARR 110 of an operating system according to embodiments of the disclosure. In one embodiment, table 300 is the same as the query table 130 of ARR 100 in FIG. 1. As illustrated, table 300 includes columns for query 302 and QS rating 304 associated with the query 302. Examples of types of queries may include, but are not limited to, a log in request, status request and creation of order request. Examples of types of QS rating may include, but are not limited to, low rating associated with the log in request, medium rating associated with the status request and high rating associated with the creation of order request.

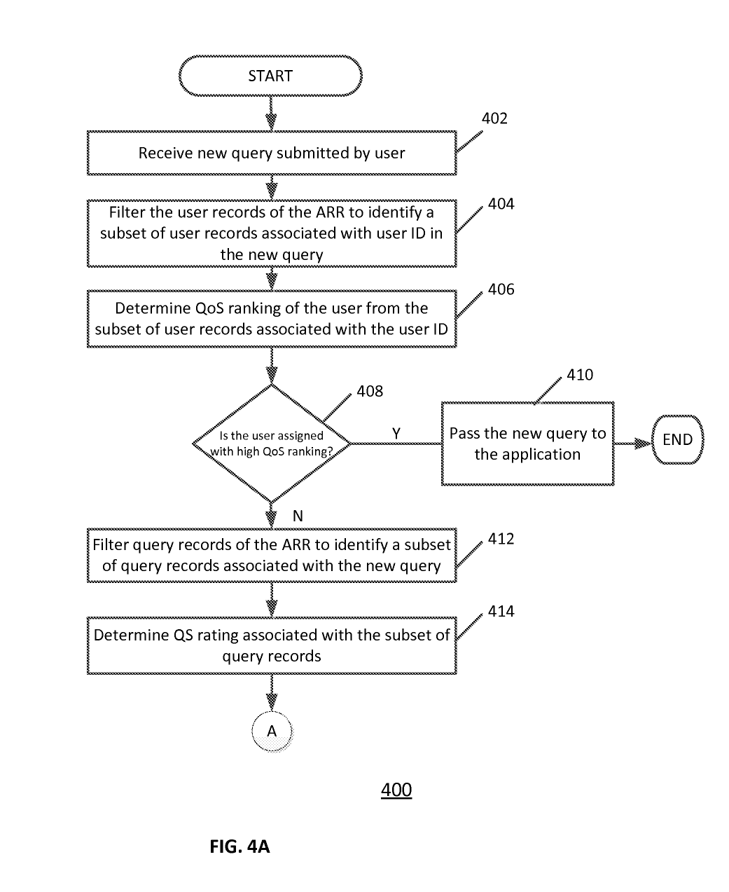

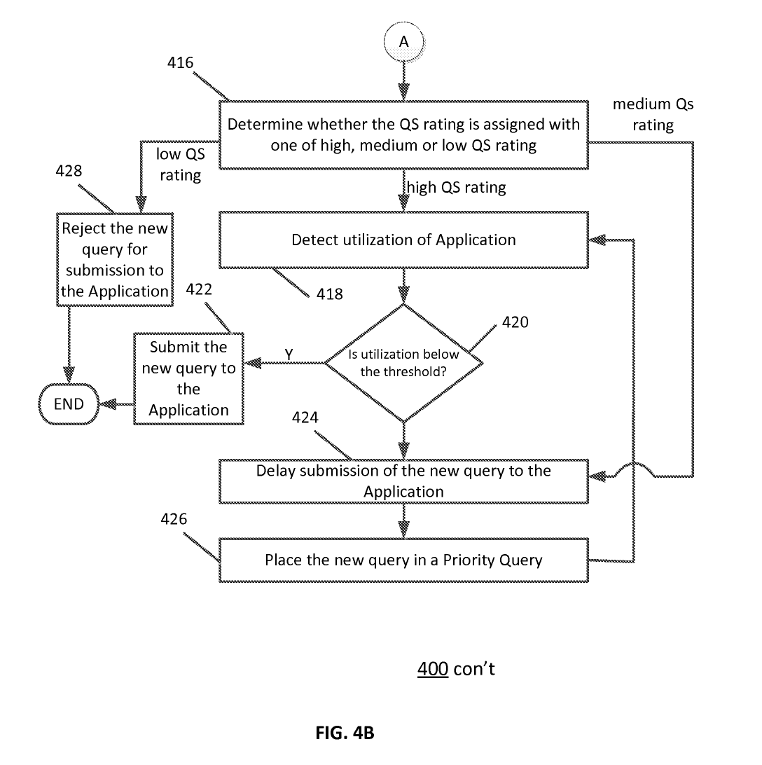

FIGS. 4A and 4B are flow diagrams illustrating a method 400 for providing overload of application according to an embodiment of the disclosure. Method 400 may be performed by processing logic that may comprise hardware (e.g., circuitry, dedicated logic, programmable logic, microcode, etc.), software (such as instructions run on a processing device), firmware, or a combination thereof. In one embodiment, method 400 is performed by DAP module 112 of FIG. 1 executing in a computing device, such as the computer system 100 of FIG. 1.

Referring to FIG. 4A, method 400 begins at block 402 where a new query submitted by a user is received at the OS 104. In one embodiment, the new query includes a user ID of the submitted user and an operation to be processed by the application. As discussed above, query is a message including an operation to be processed by the application.

At block 404, the DAP module 112 filters the user records of the ARR 110 to identify a subset of the user records associated with the user ID of the new query. At block 406, the DAP module 112 determines the QoS ranking from the subset of the user records associated with user ID.

At block 408, the DAP module 112 determines whether QoS ranking associated with the user ID is assigned with a high QoS ranking. At block 410, the DAP module 112 passes the new query to the application when it is determined that the QoS ranking associated with the user ID is assigned with the high QoS ranking. When it is determined that the QoS ranking associated with the user ID is not assigned with the high QoS ranking (e.g., is assigned a low QoS ranking), then method 400 proceeds to block 412, where the DAP module 112 filters the query records of the ARR. As such, a subset of query records associated with the new query is identified from the set of query records of the ARR 110. At block 414, the DAP module 112 determines the QS rating associated with the subset of the query records.

Continuing to FIG. 4B, at block 416, the DAP module 112 determines whether the QS rating is assigned with one of a high, medium or low QS rating. At block 418, the DAP module 112 detects utilization of the application when it is determined at block 416 that the QS rating is assigned with the high QS rating. As discussed above, utilization is amount of operations being processed in the application. At decision block 420, the DAP module 112 determines whether the utilization of the application is below a threshold.

When it is determined at decision block 420 that the utilization of the application is below the threshold, then method 400 proceeds to block 422, where the DAP module 112 submits the new query to the application. On the other hand, when it is determined at decision block 420 that the utilization of the application is not below the threshold, then method 400 proceeds to block 424, where the DAP module 112 delays submitting the new query to the application. At block 426, the DAP module places the new query in a priority queue.

Upon determination at block 416 that the QS rating is assigned with the medium QS rating, block 424 is repeated such that the DAP module 112 delays submitting the new query to be sent to the application. Block 426 is repeated such that the DAP module 112 places the new query in the priority queue. At block 428, the DAP module 112 rejects the new query to be sent to the application when it is determined at block 416 that the QS rating is assigned with the low QS rating.

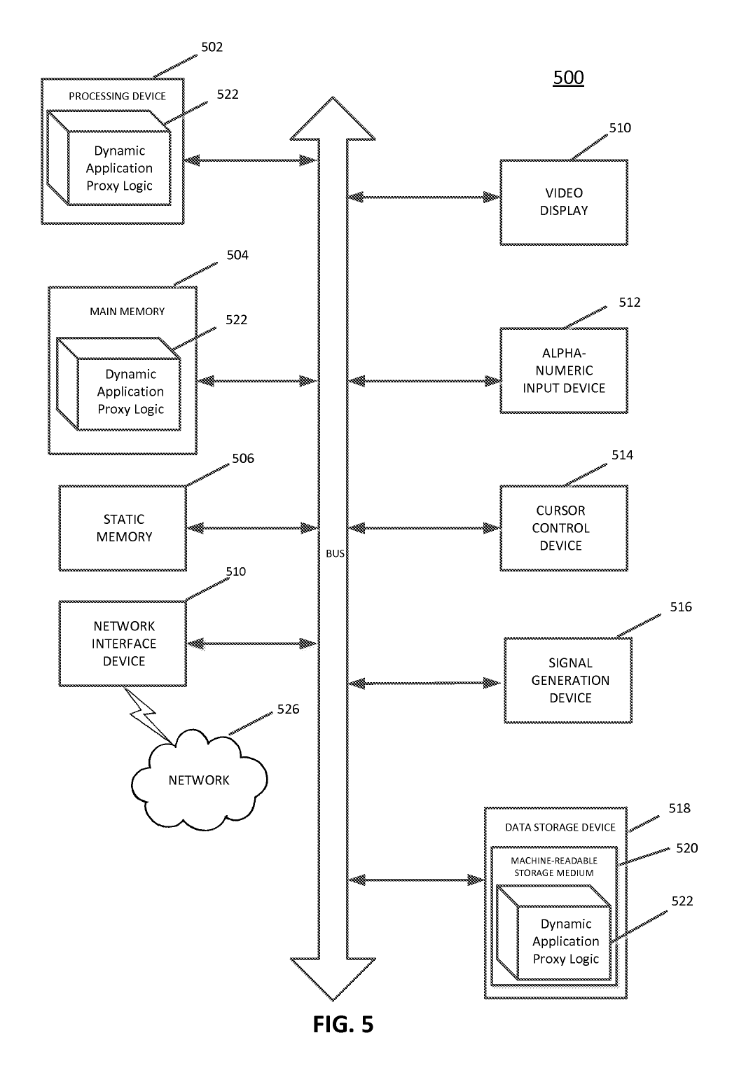

FIG. 5 illustrates a diagrammatic representation of a machine in the example form of a computer system 500 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a memory 504 (e.g., read-only memory (ROM), flash memory, dynamic random access memory (DRAM) (such as synchronous DRAM (SDRAM) or Rambus DRAM (RDRAM), etc.), a static memory 506 (e.g., flash memory, static random access memory (SRAM), etc.), and a data storage device 518, which communicate with each other via a bus 530.

Processing device 502 represents one or more general-purpose processing devices such as a microprocessor, central processing unit, or the like. More particularly, the processing device may be complex instruction set computing (CISC) microprocessor, reduced instruction set computer (RISC) microprocessor, long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 is configured to execute dynamic application proxy logic 522 for performing the operations and steps discussed herein. In one embodiment, dynamic application proxy module 112 described with respect to FIG. 1 performs the dynamic application proxy logic 522.

The computer system 500 may further include a network interface device 508. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 516 (e.g., a speaker).

The data storage device 518 may include a machine-accessible storage medium (or more specifically a computer-readable storage medium) 520 on which is stored one or more sets of instructions (e.g. dynamic application proxy logic 522) embodying any one or more of the methodologies of functions described herein, such as method 400 for preventing overload of an application described with respect to FIGS. 4A and 4B. The dynamic application proxy logic 522 may also reside, completely or at least partially, within the memory 506 and/or within the processing device 502 during execution thereof by the computer system 500; the memory 506 and the processing device 502 also constituting machine-accessible storage media. In one embodiment, dynamic application proxy logic 522 is the same as DAP module 112 of FIG. 1.

The machine-readable storage medium 520 may also be used to store the dynamic application proxy processing logic 522 persistently containing methods that call the above applications. While the machine-readable storage medium 520 is shown in an example embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instruction for execution by the machine and that cause the machine to perform any one or more of the methodologies of the disclosure. The term “machine-accessible storage medium” shall accordingly be taken to include, but not be limited to, solid-state memories, and optical and magnetic media.

In the foregoing description, numerous details are set forth. It should be apparent, however, that the disclosure may be practiced without these specific details. In some instances, structures and devices are shown in block diagram form, rather than in detail, in order to avoid obscuring the disclosure.

Some portions of the detailed descriptions which follow are presented in terms of algorithms and symbolic representations of operations on data bits within a computer memory. These algorithmic descriptions and representations are the means used by those well-known in the data processing arts to most effectively convey the substance of their work to others well-known in the art. An algorithm is here, and generally, conceived to be a self-consistent sequence of steps leading to a desired result. The steps are those requiring physical manipulations of physical quantities. Usually, though not typically, these quantities take the form of electrical or magnetic signals capable of being stored, transferred, combined, compared, and otherwise manipulated. It has proven convenient at times, typically for reasons of common usage, to refer to these signals as bits, values, elements, symbols, characters, terms, numbers, or the like.

It should be borne in mind, however that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving”, ‘storing”, “placing”, “moving”, “providing”, “rendering” “displaying” or the like, refer to the action and processes of a computer system, or similar electronic computing device that manipulates and transforms data represented as physical (electronic) quantities within the computer system's registers and memories into other data similarly represented as physical quantities within the computer system memories or registers or other such information storage, transmission or display devices.

The disclosure also relates to an apparatus for performing the operations herein. This apparatus may be constructed for the specific purposes, or it may comprise a general purpose computer selectively activated or reconfigured by a computer program stored in the computer. Such a computer program may be stored in a machine readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct an apparatus to perform the method steps. The structure for a variety of these systems will appear as set forth in the description below. In addition, the disclosure is not described with reference to any particular programming language. It will be appreciated that a variety of programming languages may be used to implement the teachings of the disclosure as described herein.

The disclosure may be provided as a computer program product, or software that may include a machine-readable medium having stored thereon instructions, which may be used to program a computer system (or other electronic devices) to perform a process according to the disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), etc.

It is to be understood that the above description is intended to be illustrative, and not restrictive. Many other embodiments will be apparent to those well-known in the art upon reading and understanding the above description. Although the disclosure has been described with reference to specific examples of embodiments, it will be recognized that the disclosure is not limited to the embodiments described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

What is claimed is:

1. A method comprising:
receiving a query submitted by a user, the query comprising a user identification (ID) and an operation to be processed by an application;
filtering user records to identify a subset of the user records associated with the user ID;
determining, by a processing device, quality of service (QoS) ranking from the subset of user records associated with the user ID;
when the determined QoS ranking associated with the user ID comprises a high ranking, submitting, by the processing device, the query to the application;
when the QoS ranking associated with the user ID comprises a low ranking, filtering, by the processing device, query records to identify a subset of the query records associated with the query;
determining a quality string (QS) rating associated with the subset of query records; and
providing a decision on the query in view of the determined QS rating.

2. The method of claim 1, wherein the decision comprises at least one of a pass, a delay, or a rejection of the query for submission to the application.

3. The method of claim 1 wherein the providing the decision comprises detecting a utilization of the application when the determined QS rating comprises a high rating.

4. The method of claim 3 further comprises passing the query to the application when the utilization is below a threshold.

5. The method of claim 3 further comprises delaying the query for submission to the application when the utilization is above a threshold.

6. The method of claim 1 wherein the providing the decision further comprises delaying the query for submission to the application when the determined QS rating comprises a medium rating.

7. The method of claim 1 wherein the providing the decision further comprises rejecting the query for submission to the application when the determined QS rating comprises a low rating.

8. A system comprising:
a processing device;
a memory coupled to the processing device; and
a dynamic application proxy (DAP) executable from the memory by the processing device, the DAP module to:
receive a query submitted by a user, the query comprising a user identification (ID) and an operation to be processed by an application;
filter user records to identify a subset of the user records associated with the user ID,
determine quality of service (QoS) ranking from the subset of user records associated with the user ID,
when the determined QoS ranking associated with the user ID comprises a high ranking, submit the query to the application,
when the determined QoS ranking associated with the user ID comprises a low ranking, filter query records to identify a subset of the query record associated with the query,
determine a quality string (QS) rating associated with the subset of the query records and
render a decision on the query in view of the QS rating of the query, wherein the decision comprises at least one of a pass, a rejection, or a delay of the query for submission to the application.

9. The system of claim 8 wherein the DAP to provide the decision further comprises the DAP to detect utilization of the application when the determined QS rating associated with the query comprises a high rating.

10. The system of claim 9 wherein the DAP module further to pass the query to the application when the utilization is below a threshold.

11. The system of claim 9 wherein the DAP module further to delay the query for submission to the application when the utilization is above the threshold.

12. The system of claim 8 wherein the DAP to provide the decision further comprises the DAP to delay the query for submission to the application when the determined QS rating associated with the query comprises a medium rating.

13. The system of claim 8 wherein the DAP to provide the decision further comprises the DAP to reject the query for submission to be sent to the application when the determined QS rating associated with the query comprises a low rating.

14. A non-transitory machine-readable storage medium including data, when accessed by a processing device, cause the processing device to perform operations comprising:
receiving a query submitted by a user, the query comprising a user identification (ID) and an operation to be processed by an application;
filtering user records to identify a subset of the user records associated with the user ID;
determining, by a processing device, quality of service (QoS) ranking from the subset of user records associated with the user ID;
when the determined QoS ranking associated with the user ID comprises a high ranking, submitting, by the processing device, the query to the application;
when the QoS ranking associated with the user ID comprises a low ranking, filtering, by the processing device, query records to identify a subset of the query records associated with the query;
determining a quality string (QS) rating associated with the subset of query records; and
providing a decision on the query in view of the determined QS rating.

15. The non-transitory machine-readable storage medium of claim 14, wherein the decision comprises at least one of a pass, a delay, or a rejection of the query to be submitted to the application.

16. The non-transitory machine-readable storage medium of claim 14, wherein providing the decision comprising detecting utilization of the application when the determined QS rating associated with the first query comprises a high rating.

17. The non-transitory machine-readable storage medium of claim 16, wherein the operations further comprising passing the query to the application when the utilization is below the threshold.

18. The non-transitory machine-readable storage medium of claim 16, wherein the operations further comprising delaying the query for submission to the application when the utilization is above the threshold.

19. The non-transitory machine-readable storage medium of claim 14, wherein providing the decision comprising delaying the query for submission to the application when the determined QS rating associated comprises a medium rating.

20. The non-transitory machine-readable storage medium of claim 14, wherein providing the decision comprising rejecting the query for submission to the application when the QS rating associated with the query comprises a low rating.
